(19) United States
(12) Patent Application Publication
(10) Pub. No.: US 2008/0192642 A1
(43) Pub. Date: Aug. 14, 2008

(54) Determination of Quality of Service Parameters of a Network from a Radio Communication Terminal

(76) Inventors: Sylvain Squedin, Nozay (FR); Olivier Martinot, Draveil (FR); Stephane Betge-Brezetz, Paris (FR); Emmanuel Marilly, Saint-Michel-Sur-Orge (FR); Mohamed Adel Saidi, Antony (FR); Gerard Delegue, Cachan (FR)

Correspondence Address: SUGHRUE MION, PLLC, 2100 PENNSYLVANIA AVENUE, N.W., SUITE 800, WASHINGTON, DC, 20037, US

(21) Appl. No.: 10/591,677

(22) PCT Filed: Feb. 28, 2005
(86) PCT No.: PCT/FR2005/000470

§ 371 Date: Dec. 6, 2006

(30) Foreign Application Priority Data
Mar. 4, 2004 (FR) 0450448

(51) Int. Cl. H04L 12/26

(52) U.S. Cl. 370/252

(57) ABSTRACT

Radio communication terminal (M₁) including communication means providing a connection to one or more application servers (AS) via a communication network (RAN₁ CN, SN). It is characterized in that it includes measurement means adapted to send at least one message to at least one application server and to determine at least one quality of service measurement as a function of the response(s) to said at least one message.

The present invention relates to a radio communication terminal and more particularly to a third generation (3G) or 2.5 generation (2.5G) terminal.

In the prior art, a communication terminal is connected to an access communication network via a radio link connecting it to a base station. The access network is itself connected to a core network that is used to place calls between communication terminals that do not belong to the same access network and to access services that are available on application servers.

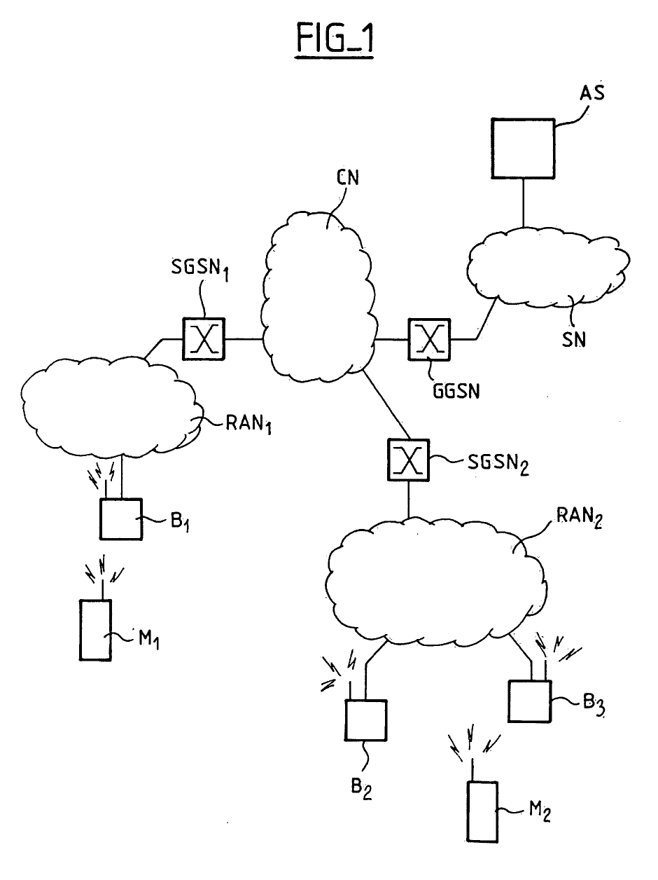

FIG. 1 shows this kind of network interconnection in the context of a third generation infrastructure.

A mobile terminal M₁ is connected to a radio access network RAN₁ via a base station B₁ (in the Universal Mobile Telecommunication System (UMTS), a base station is called a “Node B”). In the same way, a mobile M₂ is connected to a radio access network RAN₂ via a base station B₂.

These mobile terminals may be mobile telephones of the UMTS, i-mode, GPRS, etc. type or personal digital assistants (PDA).

The access networks RAN₁ and RAN₂ are connected to a core network CN by respective gateways SGSN₁ and SGSN₂ in the form of Serving GPRS Support Nodes (SGSN) and provide the interface between the access network and the core network, which may be of the General Packet Radio Service (GPRS) type.

Similarly, the core network CN may be connected to a service network SN via a gateway GGSN in the form of a Gateway GPRS Support Node that provides an interface between the protocols of the core network (for example GPRS) and those of the service network (X.25, IP, etc.).

This service network may be the Internet. Application servers AS containing applications or services available to the users of the mobile terminals M₁ and M₂ are connected to this service network.

The services available include interactive services, such as games, which necessitate high levels of quality of service. It is important to the user for the response time of the application to be as short as possible and, in the case of a multiple player game, it is important for each player to enjoy a response time that is substantially equal to that of his adversaries.

It is therefore important for the user of a mobile terminal to obtain the best possible quality of service on all networks connecting his terminal to the application server on which the chosen game is situated.

In the prior art the same game (more generally, the same application) is available on a plurality of application servers that may be at different geographical locations and accessible via different networks offering diverse qualities of services. Consequently, the choice of application server may impact on the overall quality of service perceived by the user.

However, at present, the user has no effective means of making that choice.

At present, the only way to estimate the quality of the connection is the reception level indicator. However, this kind of indicator is clearly inadequate since it is representative only of the quality of the radio link between the mobile terminal and the base station, for example between M₁ and B₁.

It gives no indication as to the quality of service of that link and of the networks connecting the base station and the application server(s), i.e. connecting B₁ and AS.

The object of the invention is to alleviate these drawbacks by enabling the user of a mobile terminal to obtain a measurement of the quality of service of the connection between his terminal and one or more application servers.

To this end, the invention consists in a mobile radio communication terminal including communication means providing a connection to one or more application servers via a communication network. This radio communication terminal is characterized in that it includes measurement means adapted to send at least one message to at least one application server and to determine at least one quality of service measurement as a function of the response(s) to said at least one message.

In various embodiments of the invention, the radio communication terminal may include means for displaying said response(s) on a display screen.

It may further include automatic selection means for determining a set of application servers providing a given application, for obtaining from said measurement means a measurement relating to each of the application servers of said set, and for automatically choosing an application server from the set as a function of those measurements.

The measurement means may determine a quality of service measurement as a function of the time elapsed between sending a message and receiving a response to said message. In one embodiment, the measurement means may send a burst of messages and determine a quality of service measurement by averaging the times elapsed between sending the messages of said burst and receiving the responses to the corresponding messages.

The measurement means may additionally determine a second quality of service measurement by calculating a jitter value as a function of the differences between two consecutive responses.

The radio communication terminal may include control means adapted to launch said measurement means periodically when said terminal is connected to said given application hosted by a first application server. These control means are adapted to determine if a new application server hosting said given application produces a quality of service measurement higher than that of said first application server and if appropriate to connect automatically to said new application server.

In one embodiment of the invention, the measurement means comprise an application downloaded from an application server.

In one embodiment the message is an IP packet, for example an ICMP message.

In another embodiment the message is adapted to be converted by a gateway into an IP packet, for example an ICMP message.

The invention, its features and its advantages will become more clearly apparent in the following description with reference to the appended figures.

FIG. 1, commented on above, is a diagram of a communication network into which a communication terminal of the invention may be inserted.

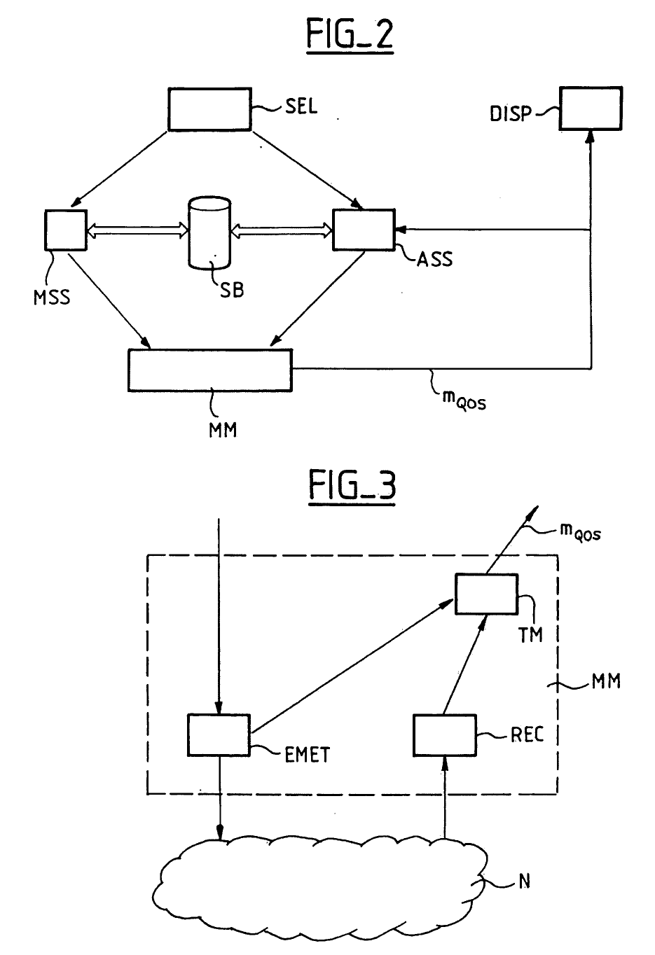

FIG. 2 is a functional view of a communication terminal of the invention.

FIG. 3 shows in more detail the functional architecture of a measurement module of the invention.

A radio communication terminal includes processing means and software means that may be stored in the main memory of the radio communication terminal or in a removable card known as the subscriber identity module (SIM card) that may be connected to the body of the terminal.

A radio communication terminal usually also has a screen and navigation means enabling the user to select functions. Selecting a function may launch one or more software modules either in the main memory or on the SIM card.

In the prior art some of these functions consist in choosing an application stored on a remote application server and initiating downloading of the application or of a portion of the application to the mobile terminal. This portion is known as a “client”, as opposed to a portion known as a “server” which remains permanently on the application server.

FIG. 2 shows the various functional modules that may be used after the user of the radio communication terminal has selected a function of this kind.

A first software module SEL enables the user to choose an application, typically a game, from a set of available applications.

The terminal also has a server base SB that associates with a given application a list of available application servers hosting that application. A function of this kind may be beneficial in making the same application accessible from various places in the world, for example, typically from several countries. It may also be beneficial for dividing the load between a plurality of application servers: users are inherently divided between the various servers hosting the requested application rather than overloading a single server. This avoids congestion of the application servers and also means that their processing capacities may be smaller.

In one embodiment of the invention, after the software module SEL has chosen a given application, a manual selection module MSS may be launched to display the corresponding list of application servers on the screen of the radio communication terminal (or one of its screens if it has more than one) to enable the user to choose the server he wishes to use.

This kind of option is beneficial in the situation where he wants to play against a computer and wishes to specify the same server for both players, for example. If the two players are also geographically close, they may be fairly sure of being connected to the same base station and thereby of obtaining substantially the same quality of service.

The manual selection module MSS may also be used to connect to one or more other terminals in a “peer to peer” mode of operation, in which the application (in particular the game) is hosted only in the communication terminals and functions through the transmission of messages.

Another option is to launch an automatic selection module ASS adapted to choose automatically a particular application server from the list associated with the application in the server base SB.

To this end, the automatic selection module includes means for interrogating the server base SB to obtain a list of available servers. The automatic selection module requests one or more quality of service measurements m_{Qos} for each of those application servers from a measurement module MM. It can then compare the measurements received for the available application servers and determine the server producing the best quality of service measurement(s).

FIG. 3 shows in more detail the functional architecture of the measurement module MM of the invention.

It includes a sender module EMET adapted to send one or more messages over the radio communication network N and a receiver module REC adapted to receive one or more responses from the same radio communication network.

If the radio communication terminal has communication means conforming to the IPv4 (Internet Protocol version 4) or IPv6 (Internet Protocol version 6) protocol, the messages and responses may be IP packets. In this case the packets may correspond to an ICMP (Internet Control Message Protocol) message as defined in the document RFC 792 from the IETF (Internet Engineering Task Force). A message of this kind may be the low-level IP command “Ping”.

If not, the messages may conform to the standard governing the radio communication network. In this case, they could be converted into and from IP packets by a module installed in the gateway SGSN. In this case they may be specifically adapted to be converted by the gateway into IP packets, for example of the “ping” type.

The measurement module MM also includes a processing module TM adapted to determine one or more quality of service measurements.

In one embodiment, this processing module may simply calculate the delay between a message sent by the sender means EMET and the response received by the receiver means REC. That delay is representative of the quality of the connection between the mobile terminal and the application server.

In another embodiment, the sender module EMET sends a burst of messages to the application server and the receiver module REC therefore receives a set of responses.

In this case the processing means TM can calculate an average delay between sending a message and receiving the response that corresponds to that message. An average delay of this kind constitutes a more accurate measurement of the quality of service between the radio communication terminal and the application server.

Moreover, in one embodiment of the invention, the processor means TM can calculate quality of service measurements other than the delay between a message and its response.

For example, if the sender module EMET sends messages at regular intervals, the processing module MT can determine the time and date of reception of the responses to those messages and calculate a jitter value, i.e. the variance of the delays between the messages and the corresponding responses.

As stated above, the quality of service measurements determined by the measurement module MM are supplied to the automatic selection module ASS. They may also be supplied to a display module DISP able to display them on a screen of the communication terminal. For example, displaying them may enable the user to confirm a server he has chosen using the manual selection module MSS or even, where appropriate, to review his choice of application and choose another application situated on other application servers producing better quality of service measurements.

An optional function is for the server base SB to associate a given application not only with a list of available application servers hosting that application but also with the delay value (“ping”) associated with each server and the number of users logged onto said server. This delay corresponds to the time that elapses between sending a message and receiving a response to said message. In this case, in the context of automatic selection, the automatic selection module ASS, which is able to choose a particular application server automatically from the list associated with the application in the server base SB, by way of a quality of service measurement moos, uses not only the value of the delay associated with said server but also the number of users logged onto said server. In the context of manual selection, which remains feasible, the display module DISP is then supplied, by way of quality of service measurement m_{Qos}, not only with the value of the delay associated with said server but also with the number of users logged onto said server, thereby enabling the user to confirm the choice he made using the manual selection module MSS, on the basis of a plurality of parameters, namely the value of the delay associated with the chosen server and the number of users logged onto the chosen server. For example, the display module DISP may display “40 ms/24/Server X”, telling the user that the server X has an associated delay of 40 ms and 24 users are logged onto it. The same goes for all the servers, from which the user may make a choice.

In one embodiment of the invention, the communication terminal also includes control means.

The control means launch the measurement means MM periodically when the radio communication terminal is connected to a given application hosted by a first application server.

It is further adapted to determine, as a function of the quality of service measurement supplied by the measurement module MM, if a new application server hosting the same application has a higher quality of service measurement than the first application server.

The control means can in this case enable the radio communication terminal to connect automatically to the new application server if it produces quality of service measurement(s) higher than those of the first application server.

This “changeover” from one application server to another may be effected dynamically and transparently for the user.

To make the changeover as transparent as possible to the user, it may be effected at propitious times for the execution of the application. In the case of a game, for example, this may be during the change to a new level, at which time an additional changeover delay of a few milliseconds would be imperceptible to the player.

In one embodiment of the invention, the measurement module may be an application downloaded from an application server. In the context of a radio communication terminal including a Java™ virtual machine, it may be a Java applet, although many other implementations are possible. The same goes for the other modules of the invention, in particular the automatic selection module ASS, and even the manual selection module MSS.

1. Radio communication terminal (M₁) including communication means providing a connection to one or more application servers (AS) via a communication network (RAN₁ CN, SN), which terminal is characterized in that it includes measurement means adapted to send at least one message to at least one application server and to determine at least one quality of service measurement as a function of the response(s) to said at least one message.

2. Radio communication terminal according to claim 1, including means for displaying said response(s) on a display screen.

3. Radio communication terminal according to claim 1, characterized in that the response displayed on a display screen indicates for each server at least the time elapsed between sending a message and receiving a response to said message and the number of users logged onto said server.

4. Radio communication terminal according to claim 1, further including automatic selection means for determining a set of application servers providing a given application, for obtaining from said measurement means a measurement relating to each of the application servers of said set, and for automatically choosing an application server from said set as a function of those measurements.

5. Radio communication terminal according to claim 1, wherein the measurement means determine a quality of service measurement as a function of the time elapsed between sending a message and receiving a response to said message.

6. Radio communication terminal according to claim 1, wherein the measurement means determine a quality of service measurement for a server as a function of the time elapsed between sending a message and receiving a response to said message and the number of users logged onto said server.

7. Radio communication terminal according to claim 1, wherein the measurement means send a burst of messages and determine a quality of service measurement by averaging the times elapsed between sending the messages of said burst and the responses to the corresponding messages.

8. Radio communication terminal according to claim 1, wherein said measurement means determine a second quality of service measurement by calculating a jitter value as a function of the differences between two consecutive responses.

9. Radio communication terminal according to claim 4, including control means adapted to launch said measurement means periodically when said terminal is connected to said given application hosted by a first application server and wherein said control means are adapted to determine if a new application server hosting said given application produces a quality of service measurement higher than that of said first application server and if appropriate to connect automatically to said new application server.

10. Radio communication terminal according to claim 1, wherein said measurement means comprise an application downloaded from an application server.

11. Radio communication terminal according to claim 1, wherein said message is an IP packet, for example an ICMP message.

12. Radio communication terminal according to claim 1, wherein said message is adapted to be converted by a gateway into an IP packet, for example an ICMP message.
